(19) United States
(12) Patent Application Publication
(10) Pub. No.: US 2014/0201015 A1
(43) Pub. Date: Jul. 17, 2014

(54) ADJUSTABLE KIOSK SYSTEM

(71) Applicant: WAL-MART STORES, INC., Bentonville, AR (US)

(72) Inventor: Robert Snyder, Rogers, AR (US)

(73) Assignee: WAL-MART STORES, INC., Bentonville, AR (US)

(21) Appl. No.: 13/743,948

(22) Filed: Jan. 17, 2013

(51) Int. Cl. G06Q 20/18; G06F 3/01

(52) U.S. Cl. CPC G06Q 20/18; G06F 3/01
USPC 705/21; 345/156

(57) ABSTRACT

A kiosk system includes: a flexible bendable user interactive display screen capable of operation when contorted, twisted or bent into different physical configurations; an operational interface in communications with the display screen; a network for access to and from the display screen via the operational interface; and a computer system for providing and receiving data to and from the display screen via the network.

### FIELD OF THE INVENTION

The present invention relates generally to a retail kiosk system for a consumer user to purchase goods from a store, and more specifically, to a kiosk system that is adjustable to fit into a physical location having space constraints where the kiosk includes a flexible bendable user interactive display screen capable of operation when contorted, twisted or bent into various physical configurations.

### BACKGROUND

Existing kiosk displays typically entail advertisement signs, boxes or banners that show select items for recognition. Additionally some kiosk displays come in the form of ATM (automatic teller machine) form factor devices, or television units that have only asynchronous consumer interactivity. Kiosks that allow consumer sales opportunities are usually quite large, requiring a relatively large footprint within a store or other location, and they also require an infrasturcutre for support, in some cases including a person to man the kiosks.

In the past kiosk displays included Cathode Ray Tubes (CRT), plasma screens, Liquid Crystal Diodes (LCD) and Light Emitting Diode (LED) screens. Each of these technologies has one or more limitations involving cost, durability, power consumption, ease of use, interactivity, ease of transport and resolution.

### BRIEF SUMMARY OF EMBODIMENTS

A kiosk system with a kiosk located at an airport, hotel lobby and other location where wireless network service is available includes a flexible bendable user interactive display screen capable of operation when contorted, twisted or bent into different physical configurations in order to fit into an area with limited space constraints. The kiosk system also includes: an operational interface in communications with, or embedded within, the display screen; a wireless network for access to and from the display screen via the operational interface; and a computer server for providing and receiving data to and from the display screen via the wireless network.

The above and other aspects of various embodiments of the present invention will become apparent in view of the following description, claims and drawings.

### BRIEF DESCRIPTION OF THE SEVERAL VIEWS OF THE DRAWINGS

The accompanying drawings, in which like numerals indicate like structural elements and features in various figures, are not necessarily drawn to scale, the emphasis instead being placed upon illustrating the principles of the invention.

FIG. 1 is a perspective side view representation of two kiosk systems according to the principles of the invention;

FIG. 2 is a schematical block diagram representation of a system according to the principles of the invention; and

FIG. 3 is a flow chart diagram of a method according to the principles of the invention.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

A preferred embodiment is a network accessible kiosk that can be placed in any location that has wired, optical, cellular or wireless access to the Internet or any other network that can access cloud based services. Companies typically use “cloud based computing services” which is a term that refers to applications, services or resources made available to users on demand via the Internet from a cloud computing provider's servers. Cloud based computing is a way to increase capacity, enhance functionality, and/or add services on demand without having to commit to potentially expensive infrastructure costs and the associated requirements for an increased number of in-house support staff.

The adjustable kiosk system includes a flexible display screen that can be mounted by being hung from a ceiling, being mounted to a wall or beam, or placed on a stand so that it can be shaped into any size to fit floor and overhead space constraints. This type of kiosk will alleviate the need for micro store front operations for retail stores during heavy holiday traffic periods. The kiosk is light and portable, allowing movement and placement by just one or two people for transport and placement at events, malls, airports, train stations, etc. The kiosk system is especially suitable for use by retail stores and can also be used for banking and other businesses.

One prominent component of the adjustable kiosk system is the flexible bendable user interactive display screen which is capable of operation when contorted, twisted or bent into different physical configurations in order to fit within a required footprint, space or volume. Although various sizes can be used, a flexible display screen dimension of 60″ by 48″ is preferred especially for retail and web service kiosks for commercial use. The flexible screen kiosk assembly can be oriented either horizontally or vertically and can be bent, twisted or contorted into any configuration for viewing and in order to best allow customer or user interaction via touch, motion or voice activation.

The flexible bendable user interactive display screen for the kiosk is preferably constructed from Organic Light Emitting Diodes (OLED) which is flat light emitting technology having a series of organic thin films placed between two conductors. Such OLED displays are available for example from Samsung™. Power for the kiosk display screen can be provided for example by a standard electrical wall outlet source, a battery power source, a solar power source, or a solar power source which charges a battery.

The adjustable kiosk system can be physically positioned anywhere that has Internet or other wired or wireless network access. For example the kiosk can be located at an airport where a user can search for products for sale from available lists, order and purchase the products, then select the pickup or delivery location (e.g. home, place of business, hotel room, or any other location). This convenience feature is desirable since a traveler can order an item needed and have it delivered to his hotel room or other destination without ever having to leave the airport.

The flexible kiosk is relatively light, compact, easy to move and easy to set up so as to be handled, transported and set up by just one or two people without special technology skills. Other favorable locations for the kiosk include but are not limited to a shopping mall, a vending machine area, a store front and a disaster relief area. When the kiosk is set up at or near an entrance of a store, then a customer user can interactively look up the products they need in the store and find the location of the products in the store using an interactive store map on the kiosk display screen.

The kiosk can be used to display a full complement of digital choices of products that are available within the retail store. The display screen can present photos of all items available for sale or available on back order, as well as presenting the customer user with pricing information. The kiosk allows the submission of credit cards, debit cards, bank account access, cash, or other payment options for which data can be submitted either via a graphical screen interface or via an attached mechanism such as a credit card reader or cash accepting machine.

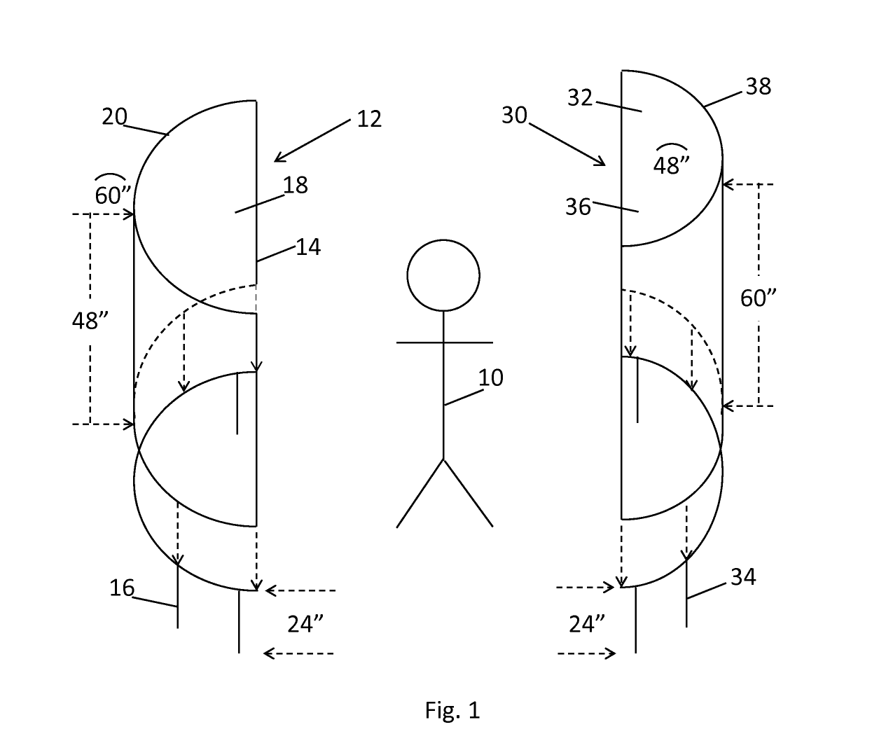

FIG. 1 is a perspective view representation of two kiosk systems 12 and 30. The kiosk system 12 includes a flexible display screen 14 which is curved with an active concave surface 18 that is 48 inches in height and 60 inches in length across the upper arcuate edge 20 of the display screen 14. The display screen is mounted on a floor stand 16 which is 24 inches in height from the ground. Of course, the dimensions of the display screen, the overall kiosk size, the height of the stand from the floor, and all other dimensions can all be varied according to specific needs.

The kiosk system 30 is presented to show a different perspective view and dimensional layout. Kiosk system 30 includes a flexible display screen 32 which is curved with an active concave surface 36 that is 60 inches in height and 48 inches in length across the upper arcuate edge 38 of the display screen 32. The display screen is mounted on a floor stand 34 which is 24 inches in height from the ground. Both kiosks 12 and 30 operate in a similar manner and multiple kiosks can be placed near one another as shown in order to accommodate a larger number of customers.

When a customer user 10 approaches the kiosk 12 a motion proximity sensor embedded in the display screen can activate the display screen, perhaps by highlighting a welcome or prompt, or by lighting the display screen up to a higher brightness level. When no customer is detected near the display screen by the motion proximity sensor for a predetermined length of time, for example, two minutes, then the display screen can enter a sleep or low power mode to conserve power. The kiosk can operate on any power source such as AC, DC, solar power, battery power, etc. When operating on alternating current AC, the system can be left ON at all times in order to display advertisements, notices, etc. on the display screen. When the kiosk 12 is powered in solar standalone mode, the system can default to be left ON at all times unless the solar panels can not sustain a minimum of 1 mAh of charge. The solar panels (not shown) can be installed into the base or stand or elsewhere for connection to the kiosk 12.

Typical voltage requirements for a flexible display unit can range between +4V to −4V for powering low columns of matrix cells or display elements on the display screen 14, and between +9V to −9V for powering longer columns of display elements on the display screen. A power supply of this type is described in U.S. Patent application no. 2012/0313862 herein incorporated by reference in its entirely for background information. Power consumption requirements can be driven by technologies such as Thinergy™ MEC battery systems, although any form fitting battery can be suitable. Notably, these power systems integrate a Display Control unit/Radio I/O device interface into the power supply.

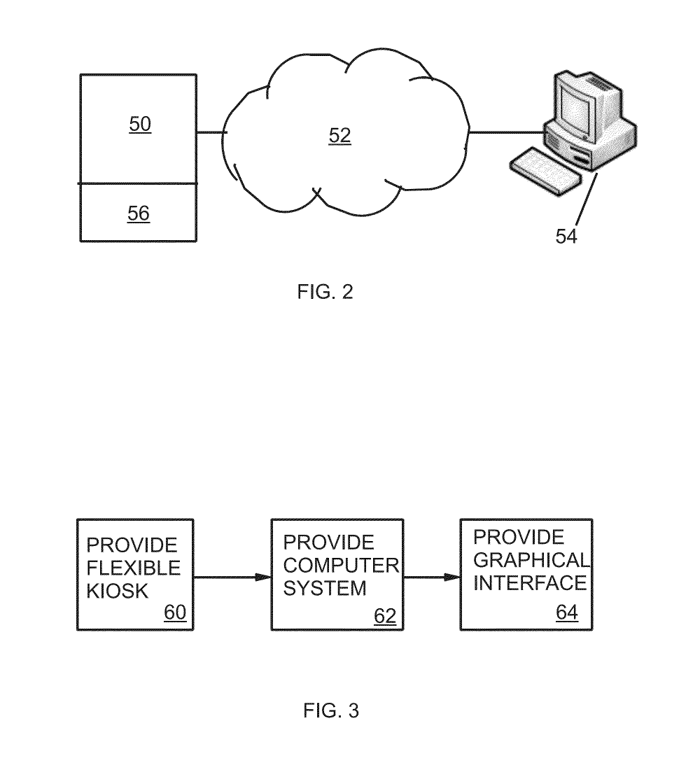

FIG. 2 shows a kiosk system 50 in communications with a server 54 via a network 52. An operational interface 56 in communications with, or directly connected to, the kiosk 50 can include additional electronics or other components for use with the kiosk. For example, the operational interface 56 can include an integrated battery controlled power supply unit that includes an integrated display control unit for controlling the kiosk display screen. Electronics such as display control electronics can be included within the operational interface. Alternatively, all of the electronics needed for operation of the display screen and communications of the display screen over a network can be embedded or integrated within the kiosk flexible display screen. In other words, the operational interface can be a part of the display screen.

As noted above, the kiosk power system can be powered by AC power, battery DC power or direct charge from a solar power charging system directly into a direct current DC battery. Preferably high capacity, low discharge battery sources are used to control power quality and signal interference from an AC/DC converter. Additionally, a battery system can act as a backup battery source for the operation of the kiosk in limited capacity mode, for example based on 4.1 VDC output at a discharge rate of 1 mAh.

Turning back to FIG. 1, the concave surface 18 of the display screen 14 can be a touch screen so the operator can activate the system via touch after being prompted by the system's motion proximity alert. The complete communications system (i.e. the complete kiosk system) as shown in FIG. 2 includes a kiosk 50 and operational interface 56, a network 52 and a computer server 54. The server 54 and kiosk 50 can be in communications with one another through the network 52 which can be wired or preferably wireless such as the Internet. The server 54 can store data pertaining to products, users or store customers, and other data that can be sent through the network 52 to the kiosk 50. The operational interface 56 can include a power source, integrated display control unit and/or other components needed or useful for the operation of the kiosk 50.

After the operator 10 has logged on to the system using the touch screen 18 of the kiosk 12 in FIG. 1, the operator can identify himself or herself as an account holder or guest in the system and can search product categories, view product data including pricing, photographs and availability, access other services and purchase goods. Additionally, the operator has the option to view existing advertisements or to order items online for pickup or delivery. If the operator (also referred to as a customer or user) is an account holder with a valid user name and password, then he or she can be presented with recommendations for products based on previous purchases or interests that are stored within a database at the server 54. The user can opt in or out of any presentation or recommendations during the ensuing session. Using Near Field Communications (NFC) technologies, the user can also be prompted to download or transfer existing session information (including receipts) to a personal communications device such as a smart phone, tablet or any other device which is capable of wireless communications to a network such as the Internet.

A preferred method of the invention is depicted by the flow chart diagram of FIG. 3 wherein a flexible kiosk as described above is provided in step 60 to a location where wireless network reception (or a hard wired network) is available. A computer system or server is provided in step 62 for facilitating communications with the kiosk over the network, and a graphical interface is provided in step 63 for a customer user to interact with the flexible display screen of the kiosk in order to search, view and purchase products available for sale from a retail store.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific embodiments, it should be understood by those skilled in the art that various changes in form and detail may be made therein without departing from the spirit and scope of the invention.

1. A kiosk system comprising:
a flexible bendable user interactive display screen capable of operation when contorted, twisted or bent into different physical configurations;
an operational interface in communications with the display screen;
a wireless network for access to and from the display screen via the operational interface; and
a computer system for providing and receiving data to and from the display via the wireless network.

2. The kiosk system of claim 1 further comprising a mount for mounting the display screen from a ceiling, a floor or a wall wherein the display screen can be oriented horizontally or vertically and the display screen is contorted, twisted or bent into a specific physical configuration to fit within a predetermined space constraint.

3. The kiosk system of claim 1 wherein the flexible bendable user interactive display screen allows user interaction via touch, motion or voice activation.

4. The kiosk system of claim 1 wherein the operational interface is connected to the display screen by one of (1) being fixedly attached to the display, (2) being embedded or integrated into the display screen, (3) cable attachment, or (4) wireless connection.

5. The kiosk system of claim 1 wherein the computer system provides data to the display screen to facilitate sales of goods from a store to a consumer user, and wherein the consumer user utilizes the interactive display screen to select and purchase goods available for sale from the store.

6. The kiosk system of claim 5 wherein the data provided from the computer system to the display screen comprises: digital images of products for sale to the display screen; availability of the products for sale; cost of the products for sale including taxes when applicable; delivery costs; payment options including acceptance of cash, credit cards and debit cards; a direct delivery option; and a store pickup option.

7. The kiosk system of claim 6 wherein the display screen comprises one or more of a touch screen interface, a voice interface and a motion interface for the consumer user to make selections for identifying and purchasing one or more of the products.

8. The kiosk system of claim 7 wherein the display screen further comprises an interactive map of locations of the products for sale in the store.

9. The kiosk system of claim 7 wherein the kiosk system is physically located at one of: a shopping mall; an airport; a hotel; a vending machine area; a disaster relief area; and a place of business.

10. The kiosk system of claim 7 wherein the kiosk system is physically located at a location having wireless communications available.

11. The kiosk system of claim 1 wherein the flexible bendable user interactive screen display screen comprises Organic Light Emitting Diodes (OLED) flat light emitting technology of a series of organic thin films placed between two conductors.

12. The kiosk system of claim 1 wherein the flexible bendable user interactive screen display screen comprises a 60″×48″ flexible monitor.

13. The kiosk system of claim 1 further comprising one of: a battery power source; a solar power source; or a solar power source charging a battery power source for power the display screen.

14. A kiosk system comprising:
a flexible bendable user interactive display screen capable of operation when contorted, twisted or bent into different physical configurations;
a mount for mounting the display screen from a ceiling, a floor or a wall wherein the display screen can be oriented horizontally or vertically and the display screen is contorted, twisted or bent into a specific physical configuration to fit within a predetermined space constraint;
an operational interface being embedded or integrated into, and in communications with the display screen;
a wireless network for access to and from the display screen via the operational interface; and
a computer system for providing and receiving data to and from the display via the wireless network.

15. A method for enabling online purchase of goods, comprising:
installing, at a site having available network communications access, a flexible bendable user interactive display screen capable of operation when contorted, twisted or bent into different physical configurations to fit within a predetermined space constraint;
providing a wireless network;
configuring an operational interface in communications with the wireless network and the display screen; and
exchanging data between a computer system and the display screen via the operational interface over the wireless network, said data including goods for sale.

16. The method of claim 15 further comprising interaction by an user via touch, motion or voice activation with the display screen to make decisions concerning the purchase of goods.

17. The method of claim 16 wherein the data exchanged between the computer system and the display screen comprises: digital images of products for sale to the display screen; availability of the products for sale; cost of the products for sale including taxes when applicable; delivery costs; payment options including acceptance of cash, credit cards and debit cards; a direct delivery option; and a store pickup option.

18. The method of claim 15 wherein the display screen further comprises an interactive map of locations of the products for sale in a store.

19. The method of claim 15 wherein the flexible bendable user interactive screen display screen comprises Organic Light Emitting Diodes (OLED) flat light emitting technology of a series of organic thin films placed between two conductors.

20. The method of claim 15 wherein the flexible bendable user interactive screen display screen comprises a 60″×48″ flexible monitor physically located at one of: a shopping mall; an airport; a hotel; a vending machine area; a disaster relief area; and a place of business.
